(19) United States
(12) Patent Application Publication
(10) Pub. No.: US 2017/0060288 A1
(43) Pub. Date: Mar. 2, 2017

(54) CAPACITIVE TOUCH SENSING WITH LUMPED SENSORS

(71) Applicants: Ramaprasad SUBRAMANIAN, Chennai (IN); Rian WHELAN, Drogheda (IE); Feargal CLEARY, Drogheda (IE)

(72) Inventors: Ramaprasad SUBRAMANIAN, Chennai (IN); Rian WHELAN, Drogheda (IE); Feargal CLEARY, Drogheda (IE)

(21) Appl. No.: 14/836,637

(22) Filed: Aug. 26, 2015

(51) Int. Cl. G06F 3/044

(52) U.S. Cl. CPC G06F 3/044

(57) ABSTRACT

In an embodiment, a touch sensing circuit comprises a plurality of sensor channels and a controller circuit coupled to the plurality of sensor channels. The controller circuit is configured to: map the sensor channels to lumped sensors; scan, during a scan period, the lumped sensors to detect touch input; and responsive to detecting touch input associated with at least one of the lumped sensors, scan the sensor channels mapped to the at least one lumped sensor.

### TECHNICAL FIELD

The subject matter of this disclosure relates generally to capacitive touch sensing.

### BACKGROUND

Human interfaces for devices and machines can include capacitive touch sensors that allow a user to provide input to control various functions of the device or machine. The capacitive touch sensors are scanned periodically to detect touch input. Power consumption by the device or machine is impacted by the number of active sensors that are scanned.

### SUMMARY

In an embodiment, a touch sensing circuit comprises a plurality of sensor channels and a controller circuit coupled to the plurality of sensor channels. The controller circuit is configured to: map the sensor channels to lumped sensors; scan, during a scan period, the lumped sensors to detect touch input; and responsive to detecting touch input associated with at least one of the lumped sensors, scan the sensor channels mapped to the at least one lumped sensor.

In an embodiment, a method of touch sensing comprises: mapping, by a controller of a touch sense circuit, sensor channels to lumped sensors; scanning, during a scan period, the lumped sensors to detect touch input; detecting touch input associated with at least one of the lumped sensors; and scanning the sensor channels mapped to the at least one lumped sensor.

In an embodiment, a touch sensing system comprises: sensor nodes; a microcontroller; and a controller coupled to the microcontroller and the sensor nodes. The controller is configured to: associate the sensor nodes with lumped sensors; scan, during a scan period, the lumped sensors to detect touch input; and responsive to detecting touch input mapped to at least one lumped sensor, scan the sensor nodes mapped to the at least one lumped sensor.

### BRIEF DESCRIPTION OF THE DRAWINGS

FIG. 1 illustrates an example capacitive touch system, according to an embodiment.

FIG. 2 illustrates lumped sensors in a capacitive touch system, according to an embodiment.

FIG. 3 illustrates a touch controller circuit for scanning mutual capacitive touch sensors, according to an embodiment.

FIG. 4 illustrates a touch controller circuit for measuring self capacitive touch sensors, according to an embodiment.

FIG. 5 illustrates various lumped sensor arrangements, according to an embodiment.

FIG. 6 is a flow diagram of an example process for a capacitive touch system with low power wake-up arrangement, according to an embodiment.

FIG. 7 is a flow diagram of an example process for a capacitive touch system with low power scan sequence, according to an embodiment.

### DETAILED DESCRIPTION

### Example Systems

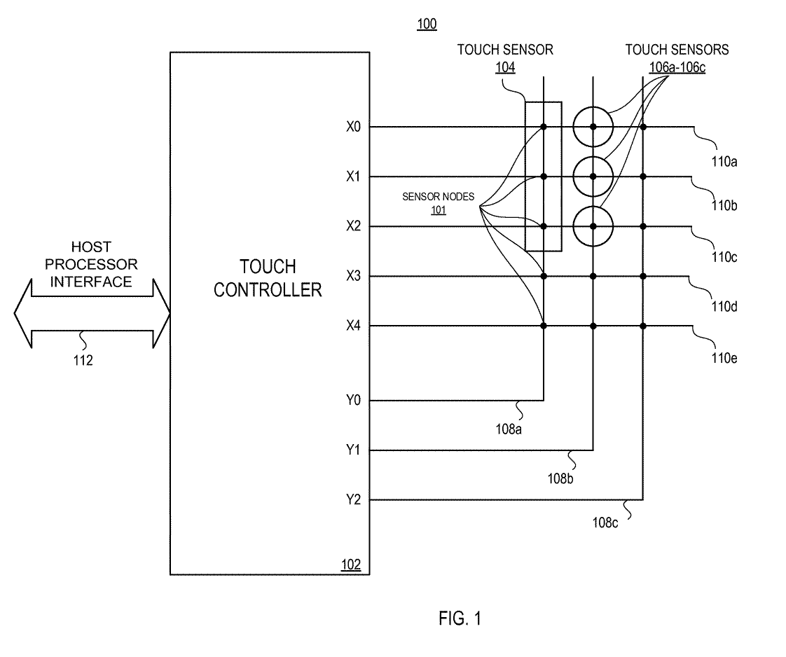

FIG. 1 illustrates an example capacitive touch system 100, according to an embodiment. In the embodiment shown, touch sensing system 100 includes touch controller 102 and capacitive touch sensors 104, 106a-106c. In the example embodiment, sensor 104 is a slider and sensors 106a-106c are buttons. Other types of capacitive touch sensors are also applicable to the disclosed embodiments (e.g., a touch wheel, touch key, touch screen). Touch sensors 104, 106 include one or more sensor nodes 101 (capacitive nodes) located at the intersections of sense electrodes 108a-108c and drive electrodes 110a-110e. Sense electrodes 108a-108c are coupled to ports Y0-Y2 of touch controller 102. Drive electrodes 110a-110e are coupled to ports X0-X4 of touch controller 102. In this example embodiment, sensor nodes 101 are laid out in an N×N grid pattern, referred to as a “sensor grid,” where N is a positive integer value greater than 1.

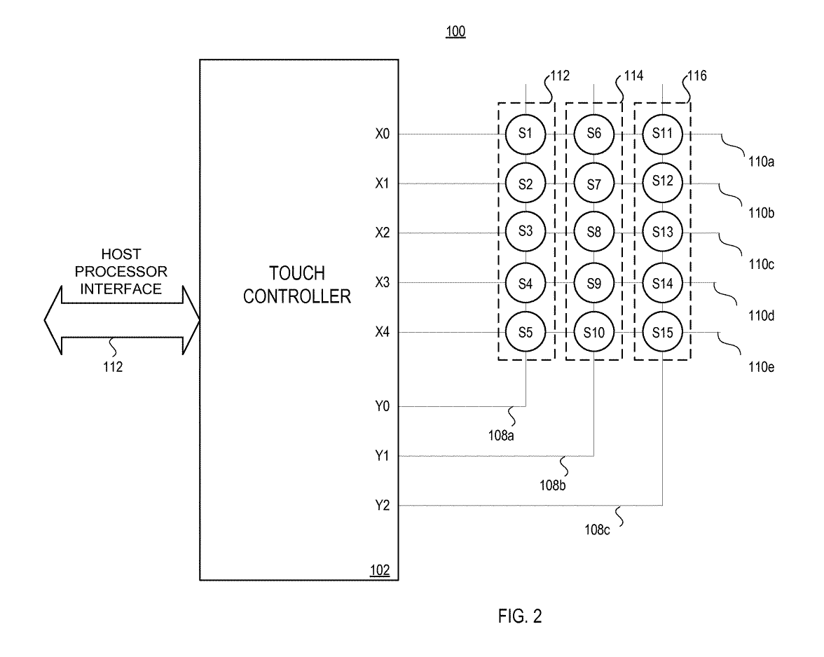

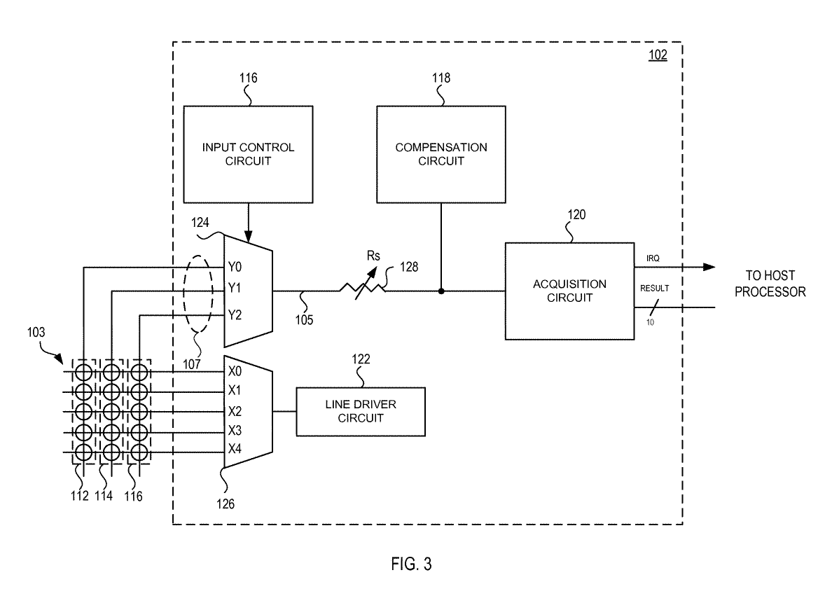

The example capacitive touch system 100 is configured for mutual capacitive sensing, where an object (e.g., finger, conductive stylus) alters the mutual coupling between sense electrodes 108a-108c and drive electrodes 110a-110e. Sensor 104 includes three sensor nodes 101. Sensors 106a-106c each include a single sensor node 101. Other sensor types may include more or fewer sensor nodes depending on the sensor size and shape. Each intersection or sensor node 101 is referred to as an “X-Y channel.” In the example embodiment shown, touch sensor 104 (a slider) is mapped to channels (X0-Y0), (X1-Y0) and (X2-Y0), and touch sensors 106a-106c (3 buttons) are mapped to X-Y channels (X0-Y1), (X1-Y1) and (X2-Y1), respectively. If an object (e.g., finger or stylus) touches touch sensor 104 one of the 15 X-Y channels will measure a change in mutual capacitance (e.g., reduced mutual capacitance) at the corresponding sensor node. For example, if an object touches slider 104, one of the X-Y channels (X0-Y0), (X1-Y0), (X2-Y0) that is mapped to slider 104 will measure a change in mutual capacitance. A change in mutual capacitance due to the addition of an object (e.g., finger) capacitance can be determined from a detection circuit in touch controller 102, as described in reference to FIGS. 2 and 3. In an embodiment, touch controller 102 can scan the 15 sensor nodes S1-S15 by scanning the X-Y channels mapped to the sensor nodes over a scan period (e.g., 25 ms). An example scan sequence is as follows: S1(X0-Y0), S2(X1-Y0), S3(X2-Y0), S4(X3-Y0), S5(X4-Y0), S6(X0-Y1), S7(X1-Y1), S8(X2-Y1), S9(X3-Y1), S10(X4-Y1), S11(X0-Y2), S12(X1-Y2), S13 (X2-Y2), S14(X3-Y2) and S15 (X4-Y2). Other scan sequences are also possible.

The scan sequence can be performed by touch controller 102 periodically during a user active period when the user is interacting with the device or machine. The user active period can start when a touch input is detected and can end when no touch inputs are detected for a specified period of time (e.g., 10 seconds). A user-inactive period is defined to be the time period between two user active periods. During a user-inactive period, the device or machine can be powered down into a sleep or low power state. When a touch input is detected, the device or machine wakes up, a new user active period is started and touch controller 102 actively scans all 15 X-Y channels to detect a touch input. Based on the X-Y channel that detects a change in mutual capacitance at the sensor nodes, the location of the touch input in the sensor grid can be determined. In an embodiment, the scanning of sensor nodes 101 is performed at least in part by firmware executed by touch controller 102.

When a device or machine is sleeping and in a user-inactive mode all 15 X-Y channels are scanned periodically to detect touch input, which consumes power. For mobile devices with limited power sources (e.g., battery operated devices), it is desirable to reduce power consumption. Rather than measure every X-Y channel during a scan period, sensor nodes 101 can be “lumped” together and treated by touch controller 102 as a single sensor. Hereinafter, a group of sensor nodes that are lumped together are referred to as a “lumped sensor.” Lumped sensors are discussed in further detail in reference to FIGS. 2-5.

In an embodiment, capacitive touch system 100 can be coupled to a microcontroller or other device through interface 112. Raw or processed touch detection data can be sent to a microcontroller (not shown) over interface 112. A host application running on a central processing unit (CPU) or peripheral of a microcontroller can process the sensor data using software/firmware, hardware or a combination of software/firmware and hardware. The sensor data can be made available to the host application through, for example, one or more Application Programming Interfaces (APIs). Data processing can include, for example, configuring individual sensor parameters (e.g., threshold and position hysteresis, position resolution), sensor acquisition parameters (e.g., filtering, automatic oversampling, gain settings, prescalers), sensor noise measurement and sensor self-calibration. Touch controller 102 can include registers (not shown) for storing data and commands that are received and transmitted over interface 112.

FIG. 2 illustrates lumped sensors in a capacitive touch system, according to an embodiment. In some implementations, capacitive touch system 100 includes touch controller 102 and touch sensors S1-S15. In this example embodiment, each of the touch sensors S1-S15 are touch buttons corresponding to a single sensor node, as described in reference to FIG. 1.

A lumped sensor includes multiple sensor nodes that are combined to act as a single touch sensor. When multiple sensor nodes are lumped together and treated as a single touch sensor by touch controller 102, the time needed to perform a scan sequence is reduced. For battery powered applications using multiple touch buttons, a group of touch buttons can be lumped together to form a single lumped sensor and this lumped sensor alone can be scanned, thereby resulting in reduced power consumption. Upon touch input detection on the lumped sensor the touch sensors included in the lumped sensor are scanned individually to determine the location of the touch input.

Referring to FIG. 2, an example embodiment is shown that includes three lumped sensors 112, 114 and 116. Lumped sensor 112 includes touch sensors S1-S5, lumped sensor 114 includes touch sensors S6-S10 and lumped sensor 116 includes touch sensors S11-S15. The grid of touch sensors S1-S15 could be, for example, a numeric keypad on a control screen, where each touch sensor is an individual button on the keypad.

To illustrate an example embodiment using lumped sensors, we can assume that touch system 100 is currently in an inactive user state. For example, no touch input is detected for a period of time (e.g., 10 seconds). While in the user inactive state, each lumped sensor is measured periodically to detect touch input. For example, lumped sensor 112 is measured by touch controller 102, followed by lumped sensor 114, followed by lumped sensor 116. The order here is only an example; lumped sensors 112, 114, 116 can be measured in any specified order. When a lumped sensor is measured, the X-Y channels mapped to the sensor nodes included in the lumped sensor 112 are scanned. For lumped sensor 112 (sensor nodes S1-S5), X-Y channels (X0-Y0), (X1-Y0), (X2-Y0), (X3-Y0), (X4-Y0) are scanned to detect a change in mutual capacitance at sensor nodes S1-S5. For lumped sensor 114 (sensor nodes S6-S10), X-Y channels (X0-Y1), (X1-Y1), (X2-Y1), (X3-Y1), (X4-Y1) are scanned to detect a change in mutual capacitance at sensor nodes S6-S10. For lumped sensor 116 (sensor nodes S11-S15), X-Y channels (X0-Y2), (X1-Y2), (X2-Y2), (X3-Y2), (X4-Y2) are scanned to determine a change in mutual capacitance at sensor nodes S11-S15. Using the lumped sensors 112, 114, 116 in the example above, touch system 100 scanned three lumped sensors during a user inactive period as opposed to 15 sensor nodes, thereby reducing power consumption.

In general, lumped sensors can be formed by shorting specific sense electrodes coupled to ports Y0-Y2 and drive electrodes coupled to ports X0-X4. In the example arrangement shown in FIG. 2, lumped sensor 112 (L1) includes sensor nodes S1-S5 and is formed by shorting the drive electrodes coupled to ports X0-X4, lumped sensor 114 (L2) includes sensor nodes S6-S10 and is formed by shorting the drive electrodes coupled to ports X0-X4 and lumped sensor 116 (L3) includes sensor nodes S11-S15 and is formed by shorting the drive electrodes coupled to ports X0-X4. Since the individual sensor nodes in lumped sensors 112, 114, 116 only use a single sense electrode coupled to ports Y0, Y1, Y2, respectively, it is not necessary to “short” any of the sense electrodes coupled to ports Y0-Y2 when forming lumped sensors 112, 114, 116. For each scan period lumped sensors L1, L2 and L3 are scanned.

Continuing with this example, if touch input is received at sensor node S1 during a scan sequence, touch controller 102 determines that S1 is part of lumped sensor L1 and the lumped sensor L1 is detected as “ON” by touch controller 102. Once L1 is detected as “ON”, touch controller 102 measurements the individual sensor nodes S1-S5 of lumped sensor L1. From these measurements, touch controller 102 determines that sensor node S1 within lumped sensor L1 is touched. Once the touch input is removed, touch controller 102 continues scanning the lumped sensors L1, L2 and L3. Accordingly, the actual individual sensor nodes included in a lumped sensor are only scanned when the lumped sensor is detected as “ON”.

In the example embodiment described above, 3 sensor nodes are measured per scan as compared to 15 sensor nodes when lumped sensors are not used, thus reducing power consumption. Additionally, the total response time when scanning lumped sensors is the time to scan 3 sensor nodes plus 5 constituent sensor nodes of a lumped sensor. Accordingly, scanning lumped sensors reduces power consumption and touch response time of touch system 100.

### Example Drift Compensation

Environmental changes affect the capacitive sensing measurement. For example, temperature and humidity causes touch controller circuit components or parameters to drift, which causes the capacitive measurements to change. If a constant reference is used to detect touch input the temperature/humidity drift may result in a false touch input. In an embodiment, a baseline compensation can be included in the scan sequence to adjust the sensor node reference level (baseline) and/or noise thresholds automatically so that low frequency noise is kept below the threshold levels to avoid false touch input detection.

To track drift of the sensor nodes in touch system 100, in addition to scanning lumped sensors periodically, the sensor nodes constituting a lumped sensor can also be scanned at regular intervals. Continuing with the previous example, and assuming a 25 ms scan interval and 500 ms drift interval, the scan sequence can be: L1+L2+L3+S1 (0 ms), L1+L2+L3+S2 (25 ms), L1+L2+L3+S3 (50 ms), L1+L2+L3+S4 (75 ms), L1+L2+L3+S5 (100 ms), L1+L2+L3+S6 (125 ms), L1+L2+L3+S7 (150 ms), L1+L2+L3+S8 (175 ms), L1+L2+L3+S9 (200 ms), L1+L2+L3+S10 (225 ms), L1+L2+L3+S11 (250 ms), L1+L2+L3+S12 (275 ms), L1+L2+L3+S13 (300 ms), L1+L2+L3+S14 (325 ms), L1+L2+L3+S15 (350 ms), L1+L2+L3+S1 (375 ms), L1+L2+L3+S2 (400 ms), L1+L2+L3+S3 (425 ms), L1+L2+L3+S4 (450 ms), L1+L2+L3+S5 (475 ms) and L1+L2+L3+S6 (500 ms). For each scan sequence of the lumped sensors L1-L3, a single sensor node S1-S15 included in one of the lumped sensors L1-L3 is scanned to track drift. A different sensor node is scanned during each scan of lumped sensors L1-L3.

FIG. 3 illustrates touch controller circuit 102 for measuring mutual capacitive touch sensors, according to an embodiment. In some implementations, touch controller 102 can include input control circuit 116, sensor channels 107, compensation circuit 118, acquisition circuit 120, line driver 122, selection circuit 124, selection circuit 126 and series resistor 128 (Rs).

In this mutual capacitance embodiment, selection circuit 124 is coupled to the sensor channels 107 and selection circuit 126 is coupled to line driver circuit 122. Line driver circuit 122 is configured to drive individual drive electrodes coupled to ports X0-X4 during a scan period using selection circuit 126. Selection circuit 126 is coupled to input control circuit 116, which is configured to select individual sensor channels 107 during a scan period. For example, to scan lumped sensor 112 selection circuit 126 shorts the drive electrodes coupled to ports X0-X4 and selection circuit 124 shorts sense channel Y0. Line driver circuit 122 provides drive voltages to the drive electrodes and, in an embodiment, can receive a selection signal (not shown) from input control circuit 116.

Acquisition circuit 120 is coupled to charge path 105 and measures the change in capacitance of a sensor node in sensor grid 103 due to touch input. In an embodiment, acquisition circuit 120 converts the measured sensor node capacitance into a digital value (e.g., 10 bit value). The count can be transferred over interface 112 (FIG. 1) to, for example, a host processor to be further processed by a hosted application. In an embodiment, an interrupt (IRQ) signal is also sent to the host processor over interface 112 to “wake up” the host processor to retrieve the count from, for example, a register (not shown) in touch controller 102.

In an embodiment, acquisition circuit 120 can include a switched capacitor circuit configured to convert sensor node capacitance to an equivalent resistor. A sigma-delta modulator circuit converts the current measured through the equivalent resistor into a bit stream, which is fed to a counter during the scan period. The counter value determines the “ON” or “OFF” status of the sensor node or lumped sensor. When touch input is received, the counter value increases and if it exceeds a reference or baseline level the sensor node has “ON” status.

Compensation circuit 118 is coupled to charge path 105 and compensates for noise. In an embodiment, compensation circuit 118 can be a capacitor network which is tuned to match sensor capacitance to provide a largest dynamic range of input signal, which improves noise tolerance.

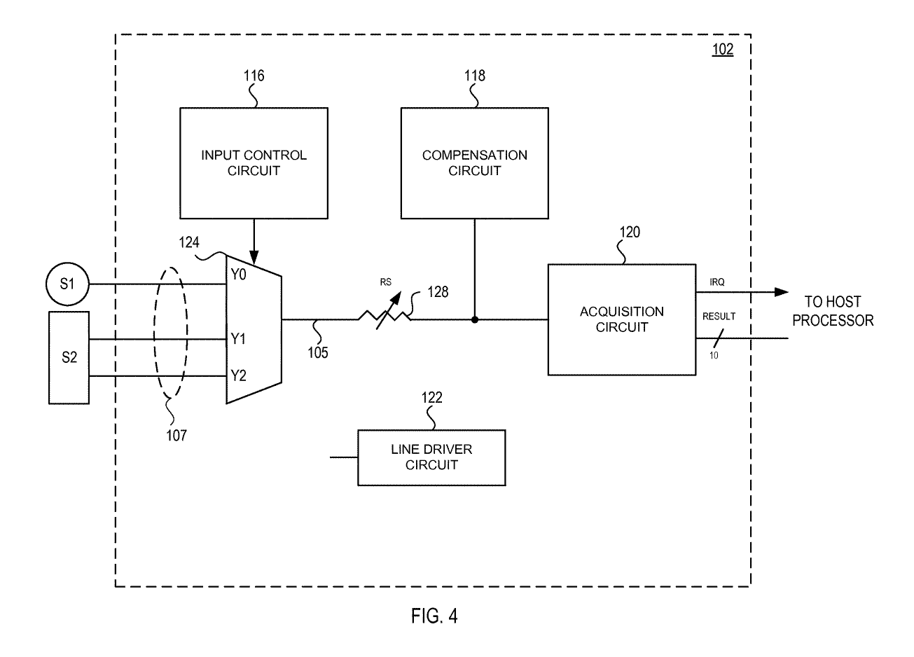

FIG. 4 illustrates a touch controller circuit 102 for measuring self capacitive touch sensors, according to an embodiment. In this example embodiment, only sense electrodes (e.g., sense electrodes 108a-108c) are coupled to self capacitance sensors and are selected using the input control circuit 116. The drive electrodes (e.g., drive electrodes 110a-110e) remain unused and can be used for other general purpose input/output functionality. The other components of touch controller 102, including compensation circuit 118 and acquisition circuit 120 operate in a similar manner as described in reference to FIG. 3.

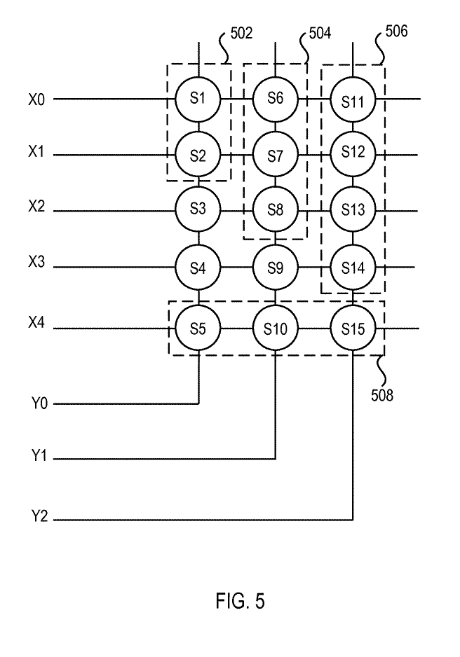

FIG. 5 illustrates various lump sensor arrangements, according to an embodiment. Lumped sensors 112, 114, 116 shown in FIGS. 2 and 3 each include sensor nodes mapped to a one sense electrode. However, lumped sensors can include any combination of sensor nodes. For example, lumped sensor 502 includes 2 sensor nodes (S1, S2) in a first column of the sensor grid, lumped sensor 504 includes 3 sensor nodes (S6, S7, S8) in a second column of the sensor grid, lumped sensor 506 includes 5 sensor nodes (S11, S12, S13, S14, S15) in a third column of the sensor grid and lumped sensor 508 includes 3 sensor nodes (S5, S10, S15) in a fifth row of the sensor grid. Other lumped sensor arrangements are also possible. In the example arrangement shown, lumped sensor 502 can be formed by shorting the drive electrodes coupled to the ports X0-X1, lumped sensor 504 can be formed by shorting the drive electrodes coupled to the ports X0-X2, lumped sensor 506 can be formed by shorting the drive electrodes coupled to the ports X0-X3 and lumped sensor 508 can be formed by shorting the sense electrodes coupled to the ports Y0-Y1. In an embodiment, the shorting can be implemented by, for example, touch controller 102 shown in FIG. 1.

### Example Processes

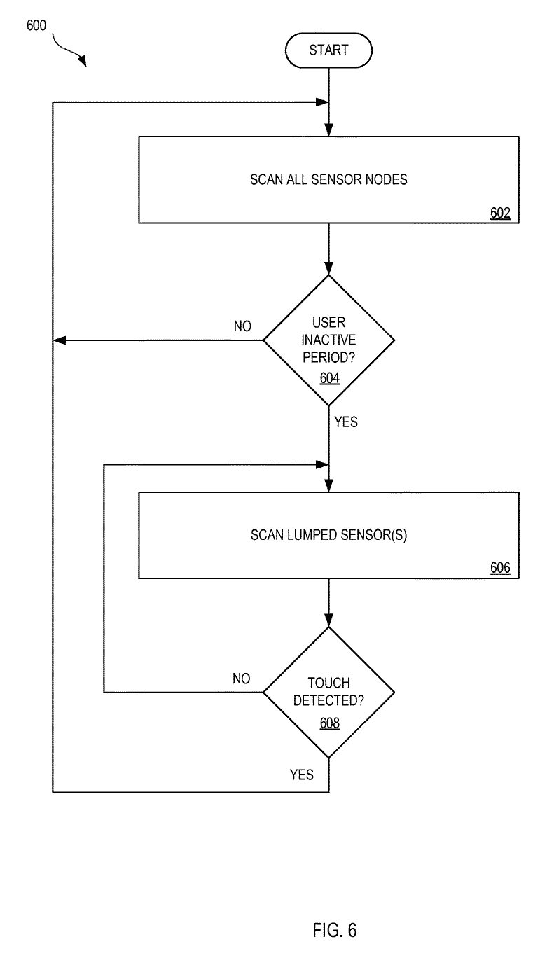

FIG. 6 is a flow diagram of an example process 600 for a capacitive touch system with low power wake-up arrangement, according to an embodiment. Process 600 can be implemented by, for example, touch system 100 shown in FIG. 1.

In an embodiment, process 600 can begin by scanning all sense nodes in a sensor grid during a user active period (602). If (604), a user inactive period is detected, process 600 continues by scanning lumped sensor (s) until touch input is detected (606). If (608) touch input is detected, process 600 ends user inactive mode, begins user active mode and once again starts scanning all the sensor nodes (602).

Process 600 reduces power consumption by only scanning lumped sensors while in user inactive mode. For example, when touch input is not detected for a period of time (e.g., 10 seconds), user inactive mode begins and only lumped sensors are scanned for touch input.

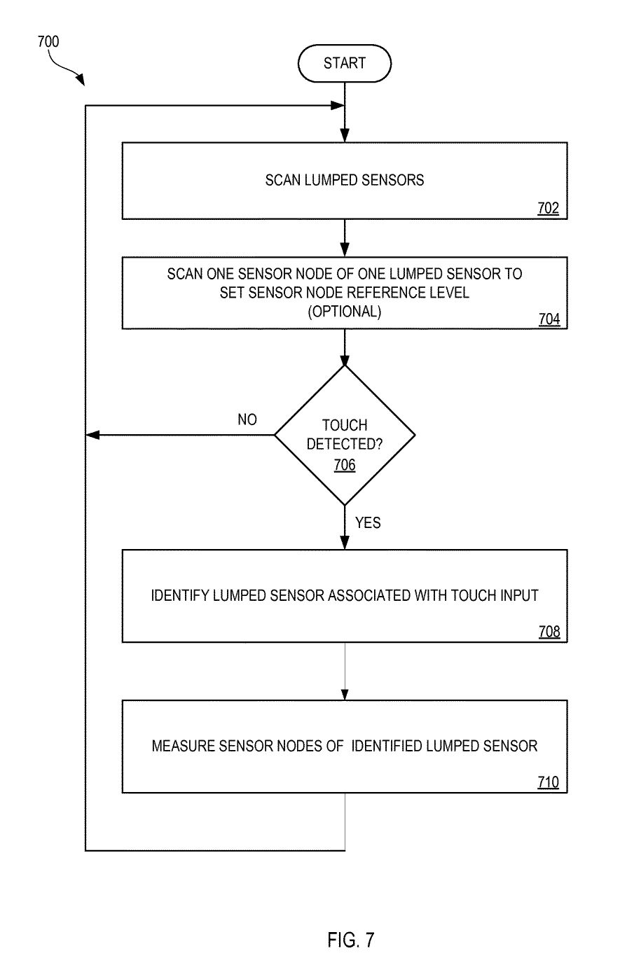

FIG. 7 is a flow diagram of an example process 700 for a capacitive touch system with low power scan sequence, according to an embodiment. Process 700 can be implemented by, for example, touch system 100 shown in FIG. 1.

In an embodiment, process 700 can begin by scanning lumped sensors until a touch input is detected (702). Optionally, one sensor node of one lumped sensor can be scanned in the same scan as the lumped sensor (704) to track drift due to, for example, temperature and/or humidity. If (706) touch input is detected, process 700 continues by identifying the lumped sensor mapped to the touch input (708) and then measuring the sensor nodes included in the lumped sensor to detect the actual location of the touch input (710).

While this document contains many specific implementation details, these should not be construed as limitations on the scope of what may be claimed but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A touch sensing circuit comprising:
a plurality of sensor channels;
a controller circuit coupled to the plurality of sensor channels, the controller circuit configured to:
map the sensor channels to lumped sensors;
scan, during a scan period, the lumped sensors to detect touch input; and
responsive to detecting touch input associated with at least one of the lumped sensors,
scan the sensor channels mapped to the at least one lumped sensor.

2. The circuit of claim 1, wherein the lumped sensors are scanned during a user inactive period.

3. The circuit of claim 1, wherein the sensor channels are mapped to one or more touch sensor types.

4. The circuit of claim 3, wherein the touch sensor type is a button.

5. The circuit of claim 3, wherein the touch sensor type is a slider.

6. The circuit of claim 1, wherein the controller circuit further comprises:
an input control circuit;
a line driver;
a first selector circuit coupled to the input control circuit, the first selector circuit configured by the input control circuit to selectively couple the sensor channels to a charge path; and
a second selector circuit coupled to the line driver, the second selector circuit configured to selectively couple the line driver to one or more drive electrodes.

7. The circuit of claim 6, further comprising:
an acquisition circuit coupled to the charge path and configured to detect a change in a sensor node capacitance and to output a digital value indicative of the detected change.

8. The circuit of claim 1, further comprising:
an interface coupled to the controller circuit, the interface configured to send touch detection data to a host processor.

9. The circuit of claim 8, wherein the interface is configured to send an interrupt signal to the host processor.

10. A method of touch sensing, comprising:
mapping, by a controller of a touch sense circuit, sensor channels to lumped sensors;
scanning, during a scan period, the lumped sensors to detect touch input;
detecting touch input associated with at least one of the lumped sensors; and
scanning the sensor channels mapped to the at least one lumped sensor.

11. The method of claim 10, wherein the lumped sensors are scanned during a user inactive period.

12. The method of claim 10, wherein the lumped sensor is mapped to one or more touch sensor types.

13. The method of claim 12, wherein the touch sensor type is a button.

14. The method of claim 12, wherein the touch sensor type is a slider.

15. The method of claim 10, further comprising:
coupling, by a first selector circuit, a touch sensor channel to a charge path; and
coupling, by a second selector circuit, a line driver to one or more drive electrodes.

16. The method of claim 15, further comprising:
detecting a change in a sensor node capacitance; and
outputting a digital value indicative of the detected change.

17. The method of claim 10, further comprising:
scanning, by the controller, one or more sensor channels mapped to lumped sensors during the scan period.

18. A touch sensing system comprising:
sensor nodes;
a microcontroller;
a controller coupled to the microcontroller and the sensor nodes, the controller configured to:
associate the sensor nodes with lumped sensors;
scan, during a scan period, the lumped sensors to detect touch input; and
responsive to detecting touch input mapped to at least one lumped sensor,
scan the sensor nodes mapped to the at least one lumped sensor.

19. The touch sensing system of claim 18, wherein the lumped sensors are scanned during a user inactive period.

20. The touch sensing system of claim 18, wherein the lumped sensors are mapped to one or more touch sensor types.
